(19) United States
(12) Patent Application Publication
(10) Pub. No.: US 2013/0151334 A1
(43) Pub. Date: Jun. 13, 2013

(54) STRATIFIED DELIVERY OF ADVERTISEMENTS BASED ON AFFINITY SCORES

(71) Applicants: PAVEL Y. BERKHIN, SUNNYVALE, CA (US); STEVEN JOHN HANKS, SEATTLE, WA (US); ROBERT PAUL GORMAN, WOODINVILLE, WA (US); RACHNA VIJAY VARGIYA, SAMMAMISH, WA (US); MANDAR DEEPAK JOSHI, REDMOND, WA (US); MOJDEH JALALI HERAVI, NEWCASTLE, WA (US)

(72) Inventors: PAVEL Y. BERKHIN, SUNNYVALE, CA (US); STEVEN JOHN HANKS, SEATTLE, WA (US); ROBERT PAUL GORMAN, WOODINVILLE, WA (US); RACHNA VIJAY VARGIYA, SAMMAMISH, WA (US); MANDAR DEEPAK JOSHI, REDMOND, WA (US); MOJDEH JALALI HERAVI, NEWCASTLE, WA (US)

(73) Assignee: MICROSOFT CORPORATION, REDMOND, WA (US)

(21) Appl. No.: 13/324,408

(22) Filed: Dec. 13, 2011

(51) Int. Cl. G06Q 30/02; G06Q 30/08

(52) U.S. Cl. 705/14.52

(57) ABSTRACT

Methods, computer systems, and computer-readable storage media for modifying an advertising bid for delivering behaviorally-targeted advertising based on affinity scores are provided. A set of affinity scores associated with users belonging to a behavioral targeting segment is received. A bid adjustment factor is dynamically calculated based on a first affinity score of the set of affinity scores; the first affinity score is associated with a first user of the set of users. The bid adjustment factor is used to modify the advertising bid such that the bid reflects an affinity of the first user for the topic associated with the behavioral targeting segment.

### BACKGROUND

Online advertisers use a variety of techniques to increase the effectiveness of their advertising campaigns. For example, online advertisers may target a particular Web page or a certain category of Web pages for their advertisements. As well, online advertisers may target specific demographic or geographic characteristics associated with users. One of the most effective techniques for targeting users is called behavioral targeting where an advertising campaign targets users who have exhibited online behaviors thought to indicate interest in or affinity to the content of the advertising campaign.

Behavioral targeting segments are determined by analyzing a user's online transactional history to determine if the user exhibits an affinity for a topic. For instance, a user's transactional history may indicate that the user is an auto enthusiast, a frequent traveler, or is in the market for a new house. Data from the user's online transactional history may be used to generate an affinity score for the user using various algorithms known in the art; the affinity score indicates a level of interest in a specified topic.

Traditionally, a user is considered to belong to a behavioral targeting segment if the calculated affinity score for a topic is greater than a predetermined threshold. For example, a user is considered to belong to an auto-enthusiast behavioral targeting segment if the user's affinity score for auto-related items is greater than a predetermined threshold. The result of this approach is that a behavioral targeting segment is composed of all users who have affinity scores greater than the predetermined threshold for that segment. However, there is no stratification of users once they are classified as belonging to a particular segment—the approach is binary; either the user is in the segment or the user is not in the segment. As such, an affinity score associated with a user is presently not utilized beyond classifying the user as in or not in a behavioral targeting segment.

The binary approach to behavioral targeting segments may be effective if the supply of advertisements targeting a particular behavioral targeting segment is substantially equivalent to the number of users in that segment. In this situation, each user is likely to receive an advertisement. However, in the frequently-encountered situation where the supply of advertisements is less than the number of users in a particular segment, the advertisements may be delivered to users with lower affinity scores as compared to users with higher affinity scores thereby decreasing the effectiveness of the advertisements and lowering the performance of the advertising campaign.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable storage media for, among other things, modifying an advertiser's bid for delivering behaviorally-targeted advertisements to a user based on affinity scores. In brief and at a high level, a set of affinity scores associated with a set of users belonging to a behavioral targeting segment is received, and a bid adjustment factor is dynamically calculated based on a first affinity score of the set of affinity scores; the first affinity score is associated with a first user of the set of users. The bid adjustment factor is used to modify the advertiser's bid for delivering behaviorally-targeted advertisements to the first user. The result is a bid price that more accurately reflects the user's interest in the topic that is the subject of the behavioral targeting segment, and hence the user's value to the advertiser.

In another embodiment of the present invention, affinity scores are used to optimize advertisement delivery by an advertisement delivery system. In brief and at a high level, an indication of a set of users belonging to a behavioral target segment is received; each user has an associated affinity score. In many cases, the distribution of affinity scores among users will not be known beforehand, so the users are sorted in descending order of affinity scores, and each user is assigned to a category based on the user's affinity score. Users having the highest affinity scores are categorized together and so on. A determination is made that advertising campaign demand for users belonging to the behavioral targeting segment is less than the number of users within the set of users, and, based on this determination, the advertisement delivery system preferentially delivers advertisements to users categorized as having the highest affinity scores.

### BRIEF DESCRIPTION OF THE DRAWINGS

The present invention is described in detail below with reference to the attached drawings figures wherein:

FIG. 1 is a block diagram of an exemplary computing environment suitable for use in implementing embodiments of the present invention;

FIG. 2 is a block diagram of an exemplary system for utilizing affinity scores to modify an advertiser's bid and optimize advertisement delivery suitable for use in implementing embodiments of the present invention;

FIG. 3 is a flow diagram that illustrates a method of modifying an advertiser's bid for delivering behaviorally-targeted advertising based on affinity scores in accordance with an embodiment of the present invention; and

FIG. 4 is a flow diagram that illustrates a method of optimizing advertisement delivery based on affinity scores in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and computer-readable storage media for, among other things, using affinity scores to modify advertisers' bids for delivering behaviorally-targeted advertising to a user belonging to a behavioral targeting segment. The user's affinity score is compared to the affinity scores of other users belonging to behavioral targeting segment, and, based on this comparison, the bids are adjusted to more accurately reflect the user's value to the advertiser.

In another embodiment, affinity scores are utilized to optimize advertisement delivery by an advertisement delivery system. Users belonging to a behavioral targeting segment are categorized based on each user's affinity score—users having the highest affinity scores are categorized together. A determination is made that the supply of behaviorally-targeted advertising is less than the number of users, and based on this determination, the advertisement delivery system preferentially delivers advertisements to the category of users having the highest affinity scores.

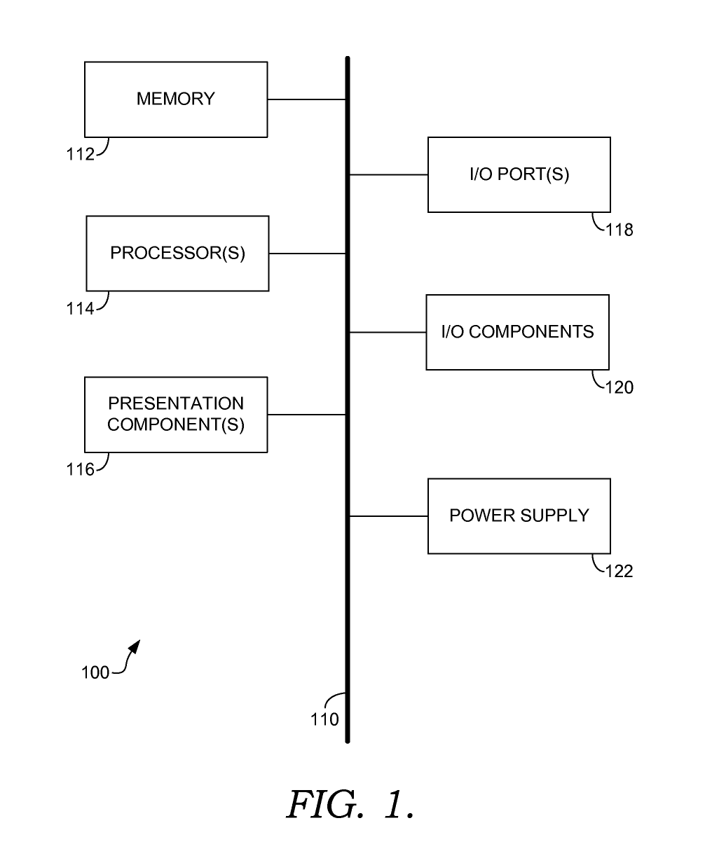

An exemplary computing environment suitable for use in implementing embodiments of the present invention is described below in order to provide a general context for various aspects of the present invention. Referring to FIG. 1, such an exemplary computing environment is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, a set of one or more processes distributed on one or more computers, one or more stand-alone storage devices, a set of one or more other computing or storage devices, a combination of one or more of the above, and the like.

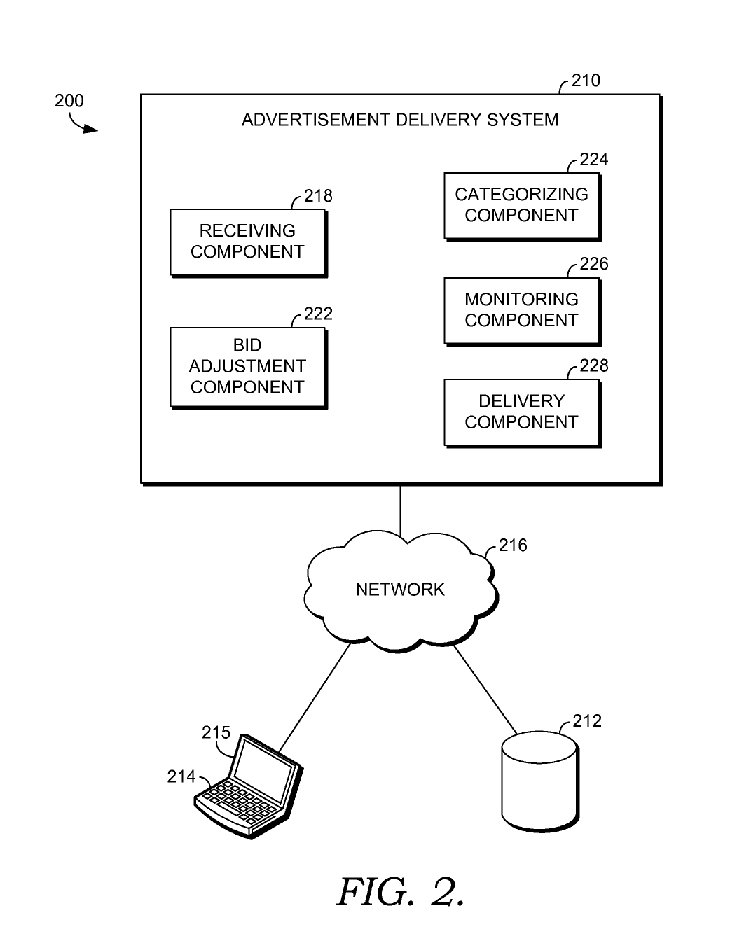

With this as a background and turning to FIG. 2, an exemplary system 200 is depicted for utilizing affinity scores to optimize advertisement delivery and modify advertisers' bids. The system 200 is merely an example of one suitable system environment and is not intended to suggest any limitation as to the scope of use or functionality of embodiments of the present invention. Neither should the system 200 be interpreted as having any dependency or requirement related to any single module/component or combination of modules/components illustrated therein.

The system 200 includes an advertisement delivery system 210, a data store 212, and an end-user computing device 214 all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

In some embodiments, one or more of the illustrated components/modules may be implemented as stand-alone applications. In other embodiments, one or more of the illustrated components/modules may be integrated directly into, for example, the operating system of the end-user computing device 214 or the advertisement delivery system 210. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the advertisement delivery system 210 might reside on a server, a cluster of servers, or a computing device remote from one or more of the remaining components. Further, the advertisement delivery system 210 may be associated with a search engine such as, for example, BING®.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store is configured to store information for use by, for example, the advertisement delivery system 210. The information stored in association with the data store 212 is configured to be searchable for one or more items of information stored in association therewith. The information stored in association with the data store 212 may comprise general information used by the advertisement delivery system 210. For example, the data store 212 may store information concerning recorded search behavior (e.g., query logs, Web pages visited, advertisement exposure, link selection, and the like) of users in general.

As well, the data store 212 may store information concerning various behavioral targeting segments and users affiliated with those segments. The data store 212 may also store calculated affinity scores associated with users in general. The affinity scores may be for one behavioral targeting segment or for many behavioral targeting segments. In one aspect, the affinity scores may be received from a third party and stored in the data store 212. In another aspect, affinity scores may be calculated by the advertisement delivery system 210 based on search behavior and subsequently stored in the data store 212. Further, the data store 212 may store information concerning users who have been categorized based on their respective affinity scores. This information may include user identities, affinity scores, and categories to which the users have been assigned.

The content and volume of such information in the data store 212 are not intended to limit the scope of embodiments of the present invention in any way. Further, though illustrated as a single, independent component, the data store 212 may, in fact, be a plurality of storage devices, for instance, a database cluster, portions of which may reside on the advertisement delivery system 210, the end-user computing device 214, a search engine, and/or any combination thereof.

The end-user computing device 214 shown in FIG. 2 may be any type of computing device, such as, for example, the computing device 100 described above with reference to FIG. 1. By way of example only and not limitation, the end-user computing device 214 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof. As shown, the end-user computing device 214 includes a display screen 215. The display screen 215 is configured to present information, including Web pages, advertisements, and/or Web-based results, to the user of the end-user computing device 214.

The system 200 is merely exemplary. While the advertisement delivery system 210 is illustrated as a single unit, it will be appreciated that the advertisement delivery system 210 is scalable. For example, the advertisement delivery system 210 may in actuality include a plurality of computing devices in communication with one another. Moreover, the data store 212, or portions thereof, may be included within, for instance, the advertisement delivery system 210 as a computer-storage medium. The single unit depictions are meant for clarity, not to limit the scope of embodiments in any form.

As shown in FIG. 2, the advertisement delivery system 210 comprises a receiving component 218, a bid adjustment component 222, a categorizing component 224, a monitoring component 226, and a delivery component 228. In some embodiments, one or more of the components 218, 222, 224, 226, and 228 may be implemented as stand-alone applications. In other embodiments, one or more of the components 218, 222, 224, 226, and 228 may be integrated directly into the operating system of a computing device such as the computing device 100 of FIG. 1. It will be understood that the components 218, 222, 224, 226, and 228 illustrated in FIG. 2 are exemplary in nature and in number and should not be construed as limiting. Any number of components may be employed to achieve the desired functionality within the scope of embodiments hereof.

The receiving component 218 is configured for a number of different things. For example, the receiving component 218 may be configured to receive an indication of a set of users belonging to a particular behavioral targeting segment along with associated affinity scores. Users belong to a behavioral targeting segment if their calculated affinity scores are above a predetermined threshold for that behavioral targeting segment. This information may be received from, for example, the data store 212 or a third-party service.

The receiving component 218 may also be configured to receive a set of affinity scores associated with a set of users. The affinity scores comprise a calculated numerical value that is normalized between some specified range—typically between zero and one. The receiving component 218 may be configured to compare each of the received affinity scores against a predetermined threshold corresponding to a particular behavioral targeting segment to determine if a user is part of that segment. For instance, if a user's affinity score is greater than the predetermined threshold, the user is considered to be part of that segment. Alternatively, the receiving component 218 may only receive affinity scores of users who have already been determined to be part of a behavioral targeting segment. The set of affinity scores may be received from the data store 212 and/or a third-party service.

In yet another aspect, the receiving component 218 may be configured to calculate affinity scores based on recorded search behavior stored in association with the data store 212 along with real-time search behavior. For instance, the receiving component 218 may receive historic transactional data pertaining to a particular topic over a variable time length along with real-time search behavior pertaining to the topic. The receiving component 218 may run any number of known algorithms across this data to generate a numerical value that gives an indication of each user's affinity for the topic. The receiving component 218 may normalize this value to a specified range and compare the normalized value to a predetermined threshold. The predetermined threshold is selected based on business considerations and balances the number of users in a behavioral targeting segment against member users' affinity to the segment's topic. Higher, and therefore more restrictive, thresholds are generally avoided because of the risk of under-delivering advertisements in cases where user demand exceeds advertiser expectations. If a user's affinity score is greater than the predetermined threshold, the user is considered part of the segment.

The bid adjustment component 222 is configured to dynamically calculate a bid adjustment factor for a user utilizing the affinity score of that user and the affinity scores associated with the set of user. The user has selected a Web page to view. As used throughout this application, the term “dynamically” means occurring in near real time. The bid adjustment factor is calculated for advertising bids arising from advertising campaigns directed to a particular behavioral targeting segment. To better understand bid adjustment factors, background regarding advertiser bidding will be provided. Advertisers bid on advertising space (impressions) appearing on a Web page—this is known as bidding on an impression request. After a user selection of a Web page is received but before the Web page is rendered, impression requests are communicated by an advertising server, such as the advertisement delivery system 210, to various advertisers. The request asks the advertisers what advertisements they would like to place on the Web page and how much they are willing to bid.

There are competing advertising campaigns for each impression request. For instance, one campaign may target the Web page itself, another might target a category of Web pages that includes the Web page, still another might target demographic and/or geographic characteristics associated with users viewing the Web page, and another might target a particular behavioral targeting segment. A decision must be made as to whom to award the impression. Generally this decision is made by awarding the impression to the highest bidder.

As mentioned above, the bid adjustment factor is applied to bids for impression requests arising from advertiser campaigns directed toward particular behavioral targeting segments. In one aspect, the bid adjustment component 222 calculates the bid adjustment factor by scaling a user's affinity score for a segment by the average score for all users in the segment. More specifically, the bid adjustment factor may be calculated according to the following formula:

$${\overline{y}}_{j} ≡ \frac{\text{?} \text{?}}{\text{?}}$$

$${b}_{i , j} = ( {y}_{i , j} - {\overline{y}}_{j} )$$

$$\text{?} \text{indicates text missing or illegible when filed}$$

where: (1) y̅ⱼ is the average affinity score for all users in the segment, j; (2) Σ_{{klkεj}}y_{k,j} is the summation of the set of affinity scores, y_{k,j} associated with the set of users, k, belonging to the behavioral targeting segment, j; (3) nⱼ is the number of users belonging to the behavioral targeting segment, j; (4) b_{i,j} is the bid adjustment factor associated with the first user, i, who belongs to the behavioral targeting segment, j; and (5) y_{i,j} is the first affinity score associated with the first user, i, and the behavioral targeting segment, j. In this case, the first user is a user who has selected the Web page to view.

The bid adjustment factor may be further modified by the bid adjustment component 222 according to the formula: b*_{i,j}=(2b_{i,j}−1)aⱼ, where b*_{i,j} is the modified bid adjustment factor, b_{i,j} is the original bid adjustment factor, and aⱼ is a segment-specific adjustment factor. The bid adjustment component 222 is then configured to apply the modified bid adjustment factor to advertising bids arising from advertising campaigns targeting the behavioral segment at issue. For example, the bid adjustment component 222 may determine a final bidding price by the following formula: b_{final}=b_{original}+b*_{i,j}, where b_{final} is final bidding price, and b_{original} is the original bidding price.

Based on the above formulas, an advertising bid is modified upward when the affinity of the first user for the topic is greater than the affinity of the set of users for the topic. Thus, if b*_{i,j} is positive in value, the advertising bid is adjusted upward. Likewise, an advertising bid is modified downward when the affinity of the first user for the topic is less than the affinity of the set of users for the topic. Thus, if b*_{i,j} is negative in value, the advertising bid is adjusted downward.

As described above, advertising campaigns targeting a particular behavior targeting segment are more likely to pay a bid premium if they know the advertisement(s) will be delivered to users who exhibit a strong affinity for the topic associated with the segment. Thus, the bid adjustment factor is applied to the advertising bid regardless of the number of available advertisements that target users in a behavioral targeting segment.

Turning now to the categorizing component 224, the categorizing component 224 is utilized in another embodiment of the invention and aids in optimizing advertisement delivery by the advertisement delivery system 210 based on affinity scores. After an indication of a set of users belonging to a behavioral targeting segment is received by the receiving component 218, the categorizing component 224 categorizes or assigns users to different categories based on each user's affinity score. Each category comprises users having affinity scores within a predetermined range of each other. Thus, users having the highest affinity scores are categorized in the same category, users having the next-highest affinity scores are assigned to a different category, and so on down the line. This process occurs in an offline setting and thereby reduces the computational demands associated with the dynamic computation of bid adjustment factors by the bid adjustment component 222. The different categories of users may be stored in association with the data store 212. In one aspect of the invention, each category comprises a substantially equal number of users.

The number of categories depends upon multiple factors including the number of users in the behavioral targeting segment, advertising demand for users in the behavioral targeting segment, and time and space constraints. For example, more categories with fewer users in each category may result in delivering advertisements to better-qualified users but may be more costly in terms of the computational demand required to prioritize impression requests.

The monitoring component 226 is configured to monitor advertising campaign demand for users belonging to a behavioral targeting segment. For instance, the monitoring component may monitor demand by monitoring the sell-through rate for advertising campaigns targeting the behavior segment at issue. The sell-through rate may be defined as the amount of available advertising space inventory that is sold and the amount that remains unsold. Because advertising space inventory is sold to different types of advertising campaigns (e.g., campaigns that target demographics and/or geographic characteristics, campaigns that target particular Web pages, etc.) advertising space directed toward behavioral targeting advertisements is often not fully sold through. For example, the sell-through rate for behavioral targeting advertisements may be less than 50% or even less than 25%; sometimes it is as low as 15%. The result of a low sell-through rate is that the supply of impressions directed to behaviorally-targeted users exceeds advertiser demand for those impressions.

In order to optimize advertisement delivery, advertisements will be preferentially delivered to the category of users having the highest affinity scores based on a determination by the monitoring component 226 that the sell-through rate is less than 50% in one aspect, and less than 25% in another aspect. The monitoring component 228 is also configured to monitor the sell-through rate for each category of users.

The delivery component 228 is configured to deliver advertisements to users. For instance, in one aspect, after the bid adjustment component 222 applies the bid adjustment factor to the advertising bid(s) originating from advertising campaigns directed to the behavioral targeting segment at issue, and the bid is accepted by the advertisement delivery system 210, the delivery component 228 delivers the advertisement(s) to the user. This may include rendering the advertisement(s) on the Web page that was selected by the user.

In another aspect of the invention, based on a determination by the monitoring component 226 that advertising campaign demand for users belonging to the behavioral targeting segment at issue is less than the number of users in the set of users (i.e, the sell-through rate is less than 50% or even less than 25%), the delivery component 228 preferentially delivers one or more advertisements to the category of users having the highest affinity scores; this process occurs in near real time. For instance, the delivery component 228 renders the advertisement(s) on the Web pages selected to be viewed by users. Because the advertisement are preferentially delivered to users categorized as having high affinity scores, the advertisement delivery system 210 ensures that only the best users in the behavioral targeting segment are delivered the advertisement(s).

Further, based on a determination by the monitoring component 226 that the advertisement(s) have been delivered to substantially all the users categorized as having the highest affinity scores (i.e., the sell-through rate for the category is close to 100%), the delivery component 228 is configured to begin preferentially delivering the advertisement(s) to the category of users having the next-highest affinity scores. This process continues for each category of users, but since advertising campaign demand is higher than the supply of advertisement(s), users with lower affinity scores may not receive the advertisement(s).

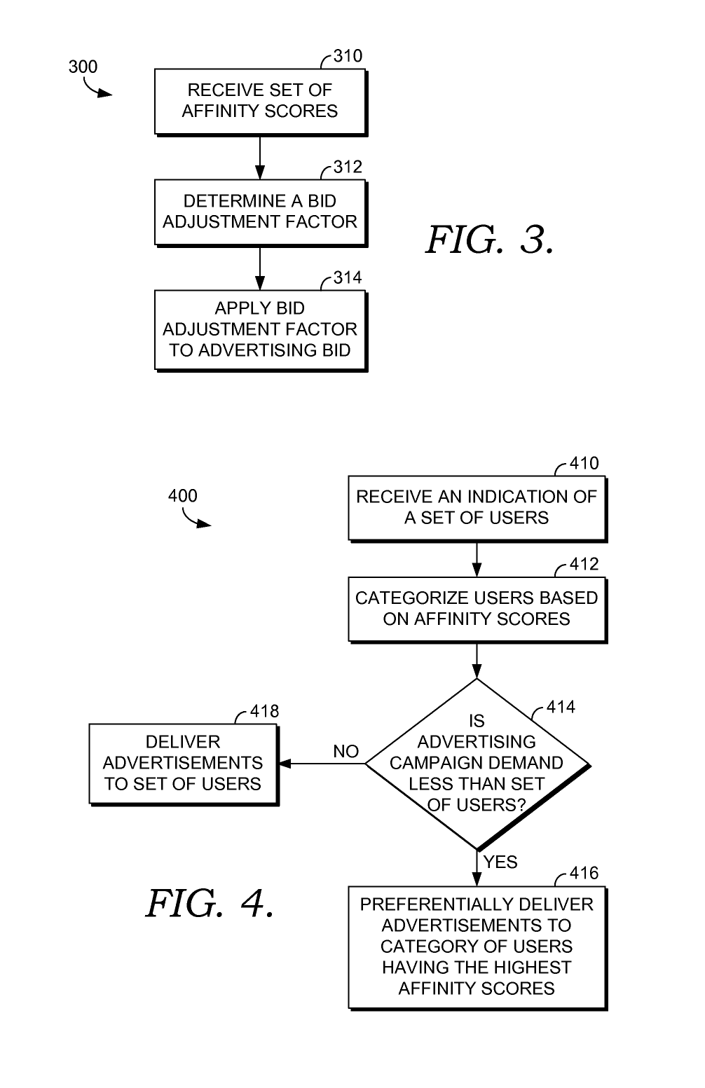

Turning now to FIG. 3, a flow diagram is depicted of a method 300 of modifying an advertising bid for delivering behaviorally-targeted advertising to a user based on affinity scores. The method 300 is generally utilized in an advertising bid auction scenario in which different advertising campaigns are bidding on impression requests received from an advertisement delivery system such as the advertisement delivery system 210 of FIG. 2. The advertising campaigns may include campaigns that target a certain Web page, a category of Web pages, demographic or geographic characteristics of users, and campaigns that target particular behavioral targeting segments.

At step 310, a set of affinity scores associated with a set of users belonging to a particular behavioral targeting segment is received by a receiving component such as, for example, the receiving component 218 of FIG. 2. At step 312, a bid adjustment factor is determined by, for example, a bid adjustment component such as the bid adjustment component 222 of FIG. 2. In one aspect, the bid adjustment component calculates the bid adjustment factor by scaling a user's affinity score for a segment by the average score for all users in the segment. More specifically, the bid adjustment factor may be calculated according to the following formula:

$${\overline{y}}_{j} ≡ \frac{\text{?} \text{?}}{\text{?}}$$

$${b}_{i , j} = ( {y}_{i , j} - {\overline{y}}_{j} )$$

$$\text{?} \text{indicates text missing or illegible when filed}$$

where: (1) y̅ⱼ is the average affinity score for all users in the segment, j; (2) Σ_{{klkεj}}y_{k,j} is the summation of the set of affinity scores, y_{k,j} associated with the set of users, k, belonging to the behavioral targeting segment, j; (3) nⱼ is the number of users belonging to the behavioral targeting segment, j; (4) b_{i,j} is the bid adjustment factor associated with the first user, i, who belongs to the behavioral targeting segment, j; and (5) y_{i,j} is the first affinity score associated with the first user, i, and the behavioral targeting segment, j. In this case, the first user is a user who has selected the Web page to view. The bid adjustment factor may be further modified according to the formula: b*_{i,j}=(2b_{i,j}−1)aⱼ, where b*_{i,j} is the modified bid adjustment factor, b_{i,j} is the original bid adjustment factor, and aⱼ is a segment-specific adjustment factor.

At step 314, the bid adjustment factor is applied to the advertising bid such that the bid reflects an affinity of the first user for the content associated with the behavioral targeting segment. For example, the final bidding price may be determined based on the formula: b_{final}=b_{original}+b*_{i,j}, where b_{final} is the final bidding price, and b_{original} is the original bidding price. Thus, when the final bid adjustment factor is positive, the advertising bid is modified upward which indicates that the affinity of the first user for the topic is greater than the affinity of the set of users for the topic. Likewise, when the final bid adjustment factor is negative, the advertising bid is modified downward thus indicating that the affinity of the first user for the topic is less than the affinity of the set of users for the topic.

Turning now to FIG. 4, a flow diagram is depicted of a method 400 of optimizing advertisement delivery by an advertisement delivery system based on affinity scores. The method 400 is optimally utilized when at least one advertising campaign directed toward a behavioral targeting segment is guaranteed delivery of one or more advertisements—this type of guaranteed delivery may be known as a reserved campaign.

At step 410, an indication of a set of users belonging to a behavioral targeting segment is received; each user of the set of users has an associated affinity score. At step 412, each user within the set of users is categorized based on a respective affinity score; users having the highest affinity scores are categorized together. This is done by a categorizing component such as the categorizing component 224 of FIG. 2. In one aspect, users having affinity scores within a predetermined range of each other are categorized together. In another aspect, each category comprises substantially the same number of users. This process may occur in an offline setting.

At step 414, a determination is made as to whether advertising campaign demand for users belonging to the behavioral targeting segment is less than the number of users within the set of users. This determination may be made by a monitoring component such as the monitoring component 226 of FIG. 2. The determination may be made by determining that the sell-through rate for advertising campaigns directed toward the behavioral targeting segment is less than, for example, 50%. In another aspect, it may be accomplished by determining that the sell-through rate for the advertising campaigns is less than, for example, 25%.

If, at step 414, it is determined that advertising campaign demand for users belonging to the behavioral targeting segment is less than the number of users within the set of users, then, at step 416, one or more advertisement(s) are preferentially delivered by a delivery component (such as the delivery component 228 of FIG. 2) to the category of users having the highest affinity scores. If, however, it is determined at step 414 that advertising campaign demand is greater than the number of users within the set of users (i.e., there are more advertisements than users within the behavioral targeting segment), then, at step 418, one or more advertisements are delivered to substantially all users within the set of users.

Continuing from step 416, once it has been determined that the advertisements have been delivered to substantially all the users in the category with the highest affinity scores, the advertisements are preferentially delivered to the category of users having the next-highest affinity scores. This process continues until all or substantially all of the advertisements have been delivered.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer-readable storage media having embodied thereon computer executable instructions that, when executed, perform a method of modifying an advertising bid for delivering behaviorally-targeted advertisements to a user based on affinity scores, the method comprising:
receiving a set of affinity scores associated with a set of users belonging to a behavioral targeting segment, the behavioral targeting segment directed toward a topic;
dynamically calculating a bid adjustment factor based on a first affinity score of the set of affinity scores, the first affinity score associated with a first user of the set of users; and
using the bid adjustment factor, modifying the advertising bid such that the advertising bid reflects an affinity of the first user for the topic.

2. The media of claim 1, wherein the method of claim 1 is utilized in an advertising bid auction scenario.

3. The media of claim 2, wherein the advertising bid auction scenario comprises an auction scenario for an impression on a Web page that the first user has selected to view.

4. The media of claim 2, wherein the advertising bid auction scenario comprises one or more advertising campaigns directed toward the behavioral targeting segment and at least one of advertising campaigns directed toward:
(A) a Web page the first user has selected to view,
(B) a category of pages that includes the Web page the first user has selected to view,
(C) a demographic characteristic similar to demographic characteristics associated with the first user, or
(D) a geographic characteristic similar to geographic characteristics associated with the first user.

5. The media of claim 1, wherein dynamically calculating the bid adjustment factor based on a first affinity score of the set of affinity scores comprises:
determining an average affinity score for the set of affinity scores; and
calculating the bid adjustment factor by subtracting the average affinity score from the first affinity score.

6. The media of claim 5, wherein the bid adjustment factor undergoes further modification before the advertising bid is modified using the bid adjustment factor.

7. The media of claim 1, wherein the advertising bid is modified upward when the affinity of the first user for the topic is greater than the affinity of the set of users for the topic.

8. The media of claim 1, wherein the advertising bid is modified downward when the affinity of the first user for the topic is less than the affinity of the set of users for the topic.

9. A computerized method carried out by an advertisement delivery system running on a processor for modifying an advertising bid for delivering behaviorally-targeted advertisements to a user based on affinity scores, the method comprising:
receiving a set of affinity scores associated with a set of users belonging to a behavioral targeting segment, the set of affinity scores comprising at least a first affinity score associated with a first user;
dynamically calculating, using the processor, a bid adjustment factor, the bid adjustment factor being calculated according to:
$${\overline{y}}_{i , j} ≡ \frac{\text{?} \text{?}}{\text{?}}$$
$${b}_{i , j} = ( {y}_{i , j} - {\overline{y}}_{j} )$$
$$\text{?} \text{indicates text missing or illegible when filed}$$
(A) wherein y̅ⱼ is the average affinity score for all users in the behavioral targeting segment, j,
(B) wherein Σ_{{klkεj}}y_{k,j} is the summation of the set of affinity scores, y_{k,j} associated with the set of users, k, belonging to the behavioral targeting segment, j,
(C) wherein nⱼ is the number of users belonging to the behavioral targeting segment, j,
(D) wherein b_{i,j} is the bid adjustment factor associated with the first user, i, who belongs to the behavioral targeting segment, j and
(E) wherein y_{i,j} is the first affinity score associated with the first user, i, and the behavioral targeting segment; and
applying the bid adjustment factor to the advertising bid.

10. The method of claim 9, wherein prior to applying the bid adjustment to the advertising bid, the bid adjustment factor is modified according to:
b*_{i,j}=(2b_{i,j}−1)aⱼ
(A) wherein b*_{i,j} is the modified bid adjustment factor,
(B) wherein b_{i,j} is the original bid adjustment factor, and
(C) wherein aⱼ is a segment-specific adjustment factor.

11. The method of claim 10, wherein if b*_{i,j} is positive, the advertising bid is adjusted upward.

12. The method of claim 10, wherein if is negative, the advertising bid is adjusted downward.

13. The method of claim 10, wherein applying the bid adjustment factor to the advertising bid comprises arithmetically adding the modified bid adjustment factor to the advertising bid.

14. One or more computer-readable storage media having embodied thereon computer executable instructions that, when executed by an advertisement delivery system, perform a method of optimizing advertisement delivery based on affinity scores, the method comprising:
receiving an indication of a set of users belonging to a behavioral targeting segment, each user of the set of users having a respective affinity score;
assigning the each user of the set of users to a category based on the user's respective affinity score, wherein users having the highest affinity scores are in a category together;
determining that advertising campaign demand for users belonging to the behavioral targeting segment is less than a number of users within the set of users; and
based on determining that the advertising campaign demand for users belonging to the behavioral targeting segment is less than the number of users within the set of users, the advertisement delivery system preferentially delivering one or more advertisements to the category of users having the highest affinity scores.

15. The media of claim 14, wherein the method of claim 14 is utilized when at least one advertising campaign directed toward the behavioral targeting segment is guaranteed delivery of one or more advertisements to a Web page that has been selected to be viewed.

16. The media of claim 14, wherein the each user of the set of users is assigned in an offline setting.

17. The media of claim 14, wherein determining that the advertising campaign demand for users belonging to the behavioral targeting segment is less than the number of users within the set of users comprises determining that the sell-through rate for advertising campaigns directed toward the behavioral targeting segment is less than 50%.

18. The media of claim 17, wherein determining that the advertising campaign demand for users belonging to the behavioral targeting segment is less than the number of users within the set of users comprises determining that the sell-through rate for advertising campaigns directed toward the behavioral targeting segment is less than 25%.

19. The media of claim 14, further comprising:
determining that the one or more advertisements have been delivered to substantially all the users in the category of users having the highest affinity scores; and
incident to determining that the one or more advertisements have been delivered to substantially all the users in the category of users having the highest affinity scores, preferentially delivering advertisements to users in a category of users having the next-highest affinity scores

20. The media of claim 14, wherein each category of users comprises users having affinity scores within a predetermined range of each other.
